(19) United States
(12) Patent Application Publication
(10) Pub. No.: US 2002/0096895 A1
(43) Pub. Date: Jul. 25, 2002

(54) Doggy dumper

(76) Inventor: Elaine McCarthy, Morro Bay, CA (US)

Correspondence Address: Elaine McCarthy, 1205 Silver Spur Place, Oceano, CA, 93445, US

(21) Appl. No.: 09/766,015

(22) Filed: Jan. 22, 2001

(51) Int. Cl. A01K 29/00

(52) U.S. Cl. 294/1.5

(57) ABSTRACT

The DOGGY DUMPER is a light weight apparatus designed to catch fecal matter as the dog voids. The deletes the task of hating to bend over, bring bags, get the mess on your hands and leave residue behind. The cup part of the apparatus is completely covered with a draw stringed bag. The string is held by two studs to keep it secure. After the dog is done the string is removed, the bag pulled closed and then thrown away. The DOGGY DUMPER remains clean and ready to store.

### II. BACKGROUND OF INVENTION

The object of the DOGGY DUMPER is to provide an efficient way to catch and dispose of dog waste without ever having to handle fecal matter Prior to the DOGGY DUMPER, the only things available were the “pooper scooper” type devices. These methods work after the dog has voided, leaving residual feces behind and a dirty scoop that must be cleaned. The DOGGY DUMPER on the other hand comes with disposable plastic bags that cover the entire area so that fecal matter is never in contact with the apparatus. A draw string is provided with the bag for easy securement and sanitary release. The DOGGY DUMPER is held under the dog as he voids. The waste is caught in the bag and thrown away. The advantage to this is that the feces never touches the ground so there is never a need to bend down to pick up a mess that will undoubtably leave residual matter behind. The DOGGY DUMPER works especially well when the animal is sick and the feces is impossible to gather. A further advantage is that the DOGGY DUMPER is light weight and easy to store. It is sanitary so it can be stored in a closet inside the home along with umbrellas and clothing. Another practical feature is the refillable plastic bag storage compartment mounted directly on the DOGGY DUMPER, so there is never a need to remember to bring bags.

While visiting numerous pet stores, websites, etc., I have never seen anything that is remotely similar to the DOGGY DUMPER. It will be the most unique invention to hit the shelves.

### III. SUMMARY OF THE INVENTION

To summarize the efficiency of the DOGGY DUMPER, it is a lightweight, easy to store, sanitary apparatus that catches waste as the dog voids. A draw string plastic bag is put on to the end of the DOGGY DUMPER, covering any and all parts that could be exposed to waste, it is then easily removed and pulled shut by the draw string so there is absolutely no contact with waste.

In conducting product analysis I have found no product similar to the DOGGY DUMPER. The closest thing to the DOGGY DUMPER are the countless array of unsanitary scoops and shovels that pick up waste rather than catch it.

### IV. BRIEF DESCRIPTION OF THE DRAWINGS

The accompanying drawings further describe the invention.

Drawing 1 of 3:

FIG. 1 shows the DOGGY DUMPER in a side angle view. The aluminium pole is 39 inches long which curves at a 45 degree angle. At the end is a bottomless cup which is one inch deep and has a diameter of 6 inches with a ¼of an inch lip that extends to hold the bag in place. On the pole at approximately the curved or angled part, are two studs to secure the bag's string. Midway up the pole is a dispenser for extra bags that can be refilled. At the end of the pole is a plastic or rubber grip equipped with a strap for easy storage.

FIG. 2 is the DOGGY DUMPER'S disposable bag design. It will be at least a gallon in size and have a drawstring manufactured within the bag.

FIG. 3 is a drawing of the DOGGY DUMPER with the bag mounted. The bag slips into the bottomless cup and wrapped beneath the ¼inch circular lip. The string is then pulled up under the first stud and looped onto the last stud giving the bag extra security. When the animal is finished voiding, the string is unlooped and the bag can easily be pulled shut and thrown away.

Drawing 2 of 3:

FIG. 4 shows a view of the DOGGY DUMPER in its up right position. It shows the bottomless nature of the cup and each dimension clearly.

Drawing 3 of 3:

FIG. 5 shows an overhead view of the DOGGY DUMPER. Also the dimensions are clearly illustrated.

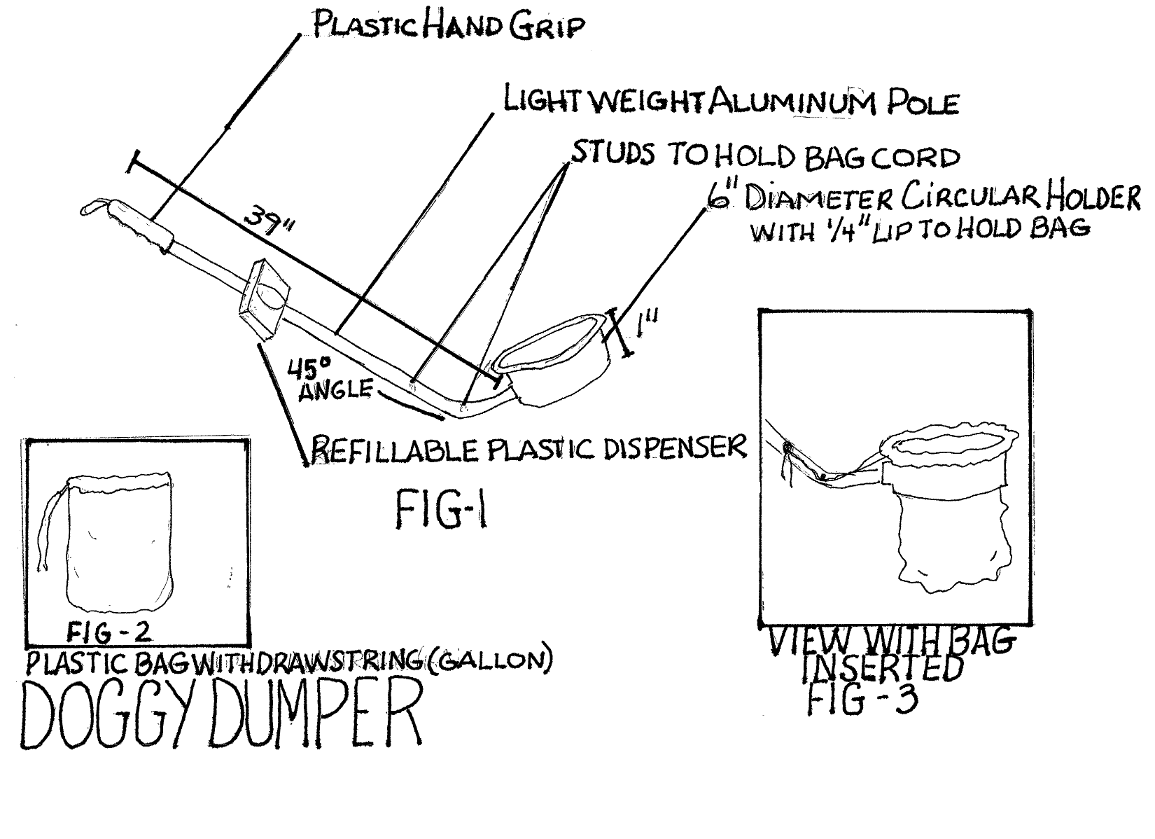

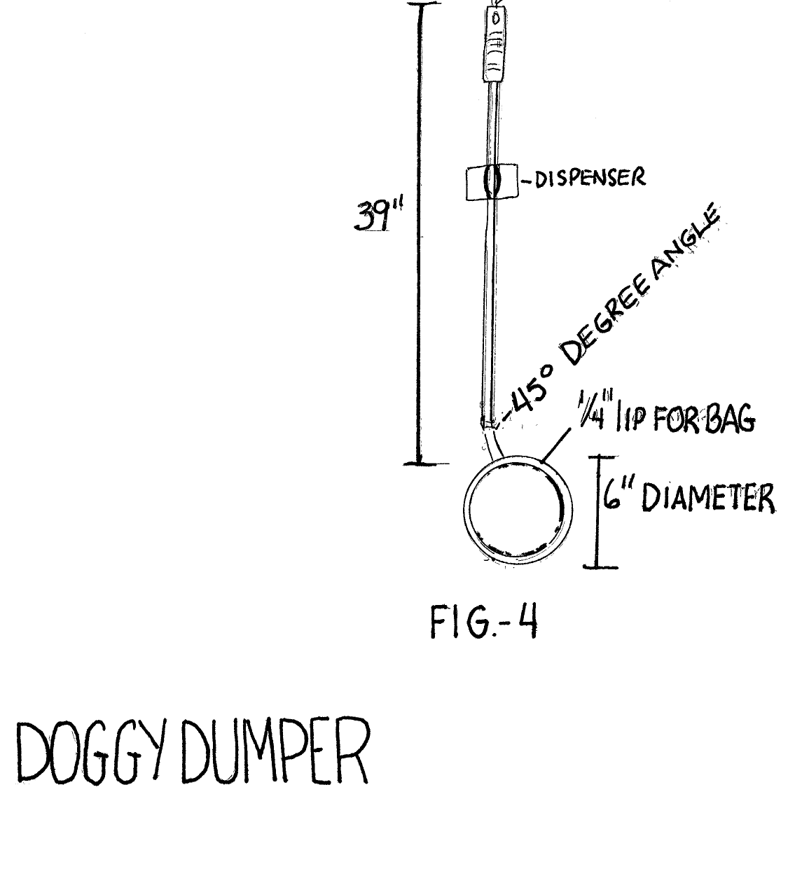

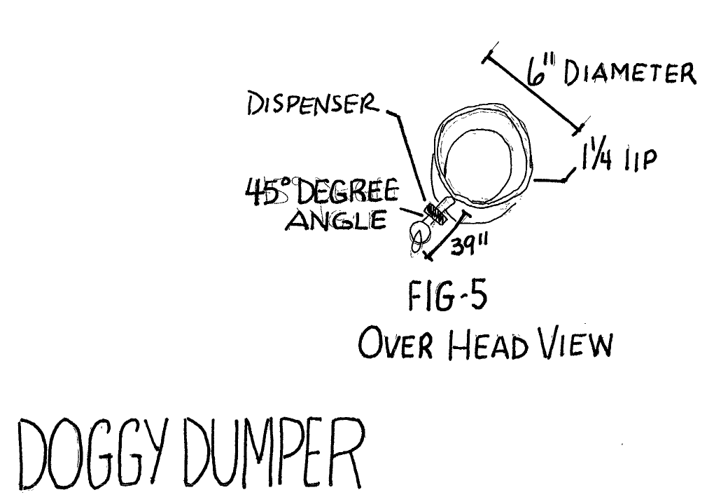

### V. DETAILED DESCRIPTION OF THE INVENTION

The DOGGY DUMPER is an innovative way to catch and dispose of dog waste. It is put beneath the dog as it voids, catching the fecal matter in a plastic bag. The plastic bag is then removed by a drawstring and thrown away.

As seen in drawing 1 of 3, the DOGGY DUMPER is made out of light weight aluminum, it won't rust and/or crack. At the end of the 39 inch pole is a round receptacle (6 inches in diameter, 1 inch long and a ¼inch lip) where the bag is placed covering the entire area. A drawstring is pulled and the bag is tightly secured to the receptacle. The DOGGY DUMPER is put beneath the dog as he voids and the fecal matter is collected in the bag. The feces never touches the ground so there is no messy clean up, and no bending down. Also when the veterinarian asks for a sample just hand him or her the bag.

Each bag is gallon and as seen in both FIGS. 2 and 3, has a built in drawstring for easy security and removal. The bag is easily removed and discarded. The DOGGY DUMPER remains clean and sanitary and can be stored anywhere within the house without worry of fecal contamination.

A refillable dispenser is mounted onto the DOGGY DUMPER so you will have extra bags on your trip and you don't need to remember to bring bags along with you. The bags would slip into the top of the dispenser and it would then be closed shut.

At the end of the DOGGY DUMPER is a rubberized grip, so that it won't slip out of your hands. On the grip is a loop to hang it up after use.

1. An innovative and hygienic way to catch and dispose of animal fecal matter.

2. The DOGGY DUMPER is made out of light weight aluminum and yet durable.

3. No picking up waste due to it's design; just place the DOGGY DUMPER beneath the dog as it voids and catch the feces.

4. No bending over due to it's design.

5. The waste is caught in a draw stringed plastic bag that covers the entire apparatus, keeping it clean.

6. The bag is removed by the drawstring and thrown away; no need for gloves or tissues. The waste is never in contact with the user.

7. A refillable dispenser is mounted onto the DOGGY DUMPER so there is never a need to remember to bring bags.

8. One size fits all; it can accommodate the largest dogs and yet is not too big or tiny dogs.

9. The DOGGY DUMPER is easy to store and sanitary so there is no risk of fecal contamination.

10. Makes a great intimidator to wandering strays.

11. Great for veterinarian requested samples.
